(19) United States
(12) Patent Application Publication
(10) Pub. No.: US 2021/0333165 A1
(43) Pub. Date: Oct. 28, 2021

(54) PRESSURE SENSOR

(71) Applicant: MIKUNI CORPORATION, Tokyo (JP)

(72) Inventors: Satoshi KANETA, Iwate (JP); Katsuhiko FUKUI, Iwate (JP)

(73) Assignee: MIKUNI CORPORATION, Tokyo (JP)

(21) Appl. No.: 17/197,065

(22) Filed: Mar. 10, 2021

(30) Foreign Application Priority Data
Apr. 27, 2020 (JP) 2020-078587

(51) Int. Cl. G01L 9/00; G01L 19/14

(52) U.S. Cl. CPC G01L 9/008; G01L 19/14

(57) ABSTRACT

Provided is a pressure sensor capable of curbing the influence of heat and securing prescribed sensor precision. The pressure sensor includes: a tubular housing (10, 20); a pressure measurement member (80) accommodated in the housing and including a piezoelectric element; a diaphragm (30) including a flexible plate-shaped portion (31) secured to a distal end of the housing and a projecting portion (32) adapted to transmit a load to the pressure measurement member; and a shielding plate (40) disposed adjacent to the flexible plate-shaped portion to shield the diaphragm from a pressure medium, and the shielding plate (40) is secured to the flexible plate-shaped portion (31) by a bonding region (A) in a linear shape.

### CROSS-REFERENCE TO RELATED APPLICATIONS

This application is based on and claims priority under 35 U.S.C. § 119 to Japanese Patent Application No. 2020-078587, filed on Apr. 27, 2020. The entire content of which is incorporated herein by reference and made a part of this specification.

### BACKGROUND

### Technical Field

The present invention relates to a pressure sensor for detecting a pressure of a pressure medium, and particularly to a pressure sensor for detecting a pressure of a high-temperature pressure medium such as a combustion gas in an engine combustion chamber.

### Description of Related Art

As a pressure sensor in the related art, a pressure sensor provided with a tubular casing, a diaphragm bonded to the casing on the distal end side and adapted to be warped in accordance with a received pressure, a sensor portion disposed in the casing, a connecting portion that connects the diaphragm to the sensor portion, and a heat receiving portion that serves as a shielding plate having a circular shape and connected at substantially a center of an outer surface of the diaphragm through welding is known (Patent Document 1, for example).

In the pressure sensor, since only the center region is welded, there is likely to be a clearance between an outer peripheral region of the diaphragm and the shielding plate. The diaphragm is exposed directly to a combustion gas at a high temperature through the clearance, and it is not possible to curb or prevent the influence of heat.

If the diaphragm is affected by heat, distortion due to thermal expansion occurs, and this leads to degradation of precision of the sensor portion

Also, if the clearance increases due to a change with time, the precision of the sensor portion is further degraded, and there is concern of the shielding plate dropping due to degradation of the welded portion.

### PATENT DOCUMENTS

[Patent Document 1] Japanese Patent Application Laid-Open No. 2017-40516

### SUMMARY

The present invention was made in view of the aforementioned circumstances, and an object thereof is to provide a pressure sensor capable of reliably shielding a diaphragm from a pressure medium at a high temperature, curbing the influence of heat and degradation with time, and detecting the pressure of the high-temperature pressure medium with high precision.

A pressure sensor according to the present invention includes: a housing formed into a tubular shape; a pressure measurement member accommodated in the housing and including a piezoelectric element; a diaphragm including a flexible plate-shaped portion secured to a distal end of the housing and a projecting portion adapted to transmit a load to the pressure measurement member; and a shielding plate disposed adjacent to the flexible plate-shaped portion to shield the diaphragm from a pressure medium, and the shielding plate is secured to the flexible plate-shaped portion by a bonding region in a linear shape.

In the aforementioned pressure sensor, the shielding plate may be linearly welded to the flexible plate-shaped portion of the diaphragm.

In the aforementioned pressure sensor, a distal end annular region of the housing may be bent to cover an outer peripheral edge of the shielding plate.

The aforementioned pressure sensor further includes: a securing member in a linear shape that is disposed adjacent to an outer side of the shielding plate and defines the bonding region, and both end portions of the securing member may be welded to the housing in a state in which the shielding plate is pressed against the flexible plate-shaped portion of the diaphragm.

In the aforementioned pressure sensor, an area of the bonding region may be equal to or less than 50% of an area of the shielding plate.

In the aforementioned pressure sensor, when the flexible plate-shaped portion and the shielding plate have a circular shape with an outer diameter dimension D, a width dimension W of the bonding region satisfies a relational expression represented as W<(π·D)/8.

In the aforementioned pressure sensor, the shielding plate may be formed of a material that has same thermal conductivity as or lower thermal conductivity than the diaphragm.

In the aforementioned pressure sensor, the securing member may be formed of the same material as the shielding plate.

In the aforementioned pressure sensor, the pressure measurement member may include a first electrode and a second electrode laminated to pinch the piezoelectric element, a first conductive element drawn from the housing with insulation may be connected to the first electrode, and a second conductive element drawn from the housing with insulation may be connected to the second electrode.

According to the pressure sensor with the aforementioned configuration, it is possible to obtain a pressure sensor capable of reliably shielding a diaphragm from a pressure medium at a high temperature, curbing the influence of heat and degradation with time, and detecting the pressure of the high-temperature pressure medium with high precision.

### BRIEF DESCRIPTION OF THE DRAWINGS

FIG. 1 is an exterior perspective view illustrating a first embodiment of a pressure sensor according to the present invention.

FIG. 2 is a sectional view along an axial line of the pressure sensor illustrated in FIG. 1.

FIG. 3 is an exploded perspective view of a sensor module included in the pressure sensor illustrated in FIG. 1.

FIG. 4 is a sectional view of the sensor module illustrated in FIG. 3.

FIG. 5 is a sectional view of the sensor module rotated 90 degrees about an axial line S relative to the section illustrated in FIG. 4.

FIG. 6 is a perspective view illustrating a bonding region in a linear shape of a shielding plate with respect to a diaphragm.

FIG. 7 is a plan view for explaining the bonding region.

FIG. 8 is a graph illustrating a relationship between a bonding area ratio (%) of the bonding region and a sensor error of the pressure measurement portion.

FIG. 9 illustrates a pressure sensor according to a modification example of the first embodiment and is a sectional view of a sensor module included in the pressure sensor.

FIG. 10 illustrates a second embodiment of a pressure sensor according to the present invention and is an exploded perspective view of a sensor module included in the pressure sensor.

FIG. 11 is a sectional view of the sensor module illustrated in FIG. 10.

FIG. 12 is a sectional view of the sensor module rotated 90 degrees about an axial line S relative to the section illustrated in FIG. 11.

### DESCRIPTION OF THE EMBODIMENTS

Hereinafter, embodiments of the present invention will be described with reference to the accompanying drawings.

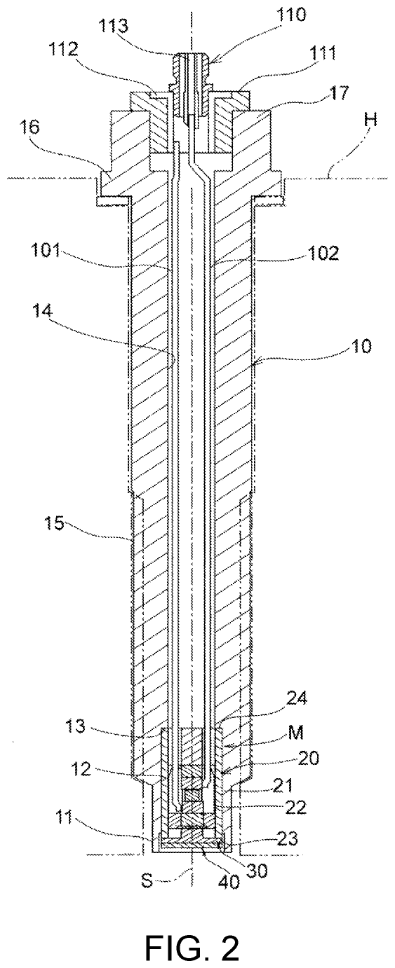

A pressure sensor according to the first embodiment is attached to a cylinder head H of an engine as illustrated in FIG. 2 to detect the pressure of a combustion gas that is a pressure medium in a combustion chamber.

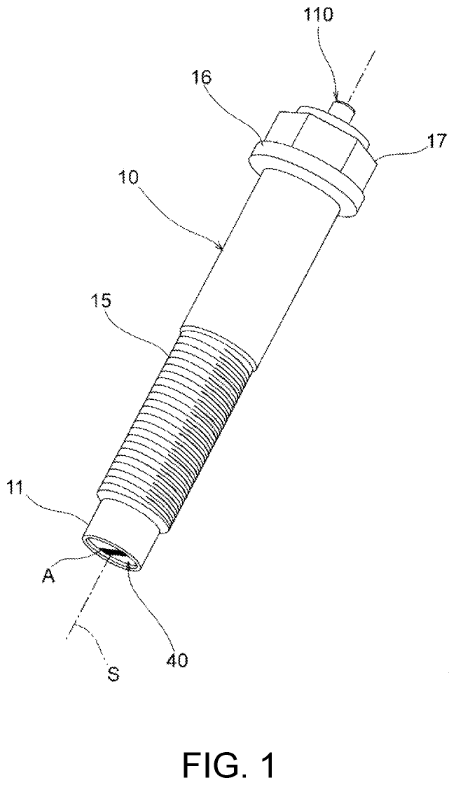

The pressure sensor according to the first embodiment includes: an outer housing 10 and a sub housing 20 as tubular housings that define an axial line S, a diaphragm 30, a shielding plate 40, a holding plate 50, a positioning member 60, a thermal insulating member 70, a pressure measurement member 80, a preload application member 90, a lead wire 101 that is a first conductive element, a lead wire 102 that is a second conductive element, and a connector 110, as illustrated in FIG. 1 to FIG. 3.

Here, the pressure measurement member 80 includes: a first electrode 81, a piezoelectric element 82, and a second electrode 83 laminated in order in the axial line S direction from the distal end side of the housing.

The preload application member 90 includes: a securing member 91 and an insulating member 92.

The outer housing 10 is formed into a tubular shape extending in the axial line S direction using a precipitation hardening-type or ferrite-based metal material such as stainless steel and includes: a distal end tubular portion 11, a fitting inner peripheral wall 12, a step difference portion 13, a penetrating path 14, a male screw portion 15 formed in the outer peripheral surface, a flange portion 16, and a connector coupling portion 17, as illustrated in FIG. 1 and FIG. 2.

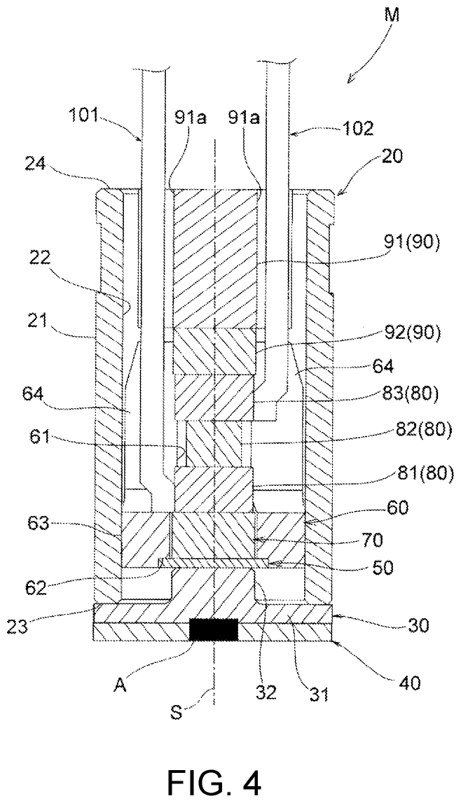

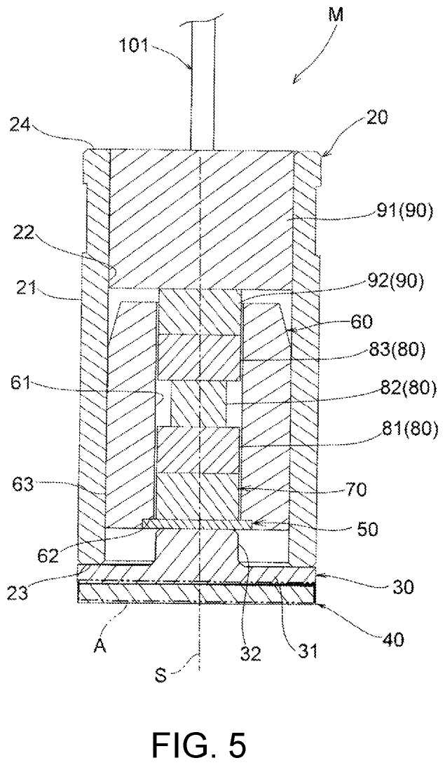

The sub housing 20 is formed into a tubular shape extending in the axial line S direction using a precipitation hardening-type or ferrite-based metal material such as stainless steel and includes: an outer peripheral wall 21 fitted to the fitting inner peripheral wall 12, an inner peripheral wall 22 around the axial line S at the center, a distal end surface 23, and a further-side end surface 24, as illustrated in FIG. 4 and FIG. 5.

Also, the sub housing 20 is fitted to the inside of the outer housing 10 and secured thereto with welding or the like in a state in which the diaphragm 30, the shielding plate 40, the holding plate 50, the positioning member 60, the thermal insulating member 70, the pressure measurement member 80, the preload application member 90, the lead wire 101, and the lead wire 102 are assembled.

The diaphragm 30 is formed of a metal material that has a precipitation hardening property, such as stainless steel, and includes: a flexible plate-shaped portion 31 and a projecting portion 32 formed to be continuous with the flexible plate-shaped portion 31, as illustrated in FIG. 4 and FIG. 5.

The flexible plate-shaped portion 31 is formed into an elastically deformable disk shape with an outer diameter equivalent to the outer diameter dimension of the sub housing 20, and an outer edge region thereof is secured to the distal end surface 23 of the sub housing 20 through welding or the like.

The flexible plate-shaped portion 31 defines an effective pressure receiving portion in a circular region that is smaller than the inner diameter of the inner peripheral wall 22 of the sub housing 20 and is adapted to be elastically deformed in the axial line S direction in response to a load in accordance with the pressure of the combustion gas acting thereon.

The projecting portion 32 is formed into a columnar shape extending in the axial line S direction from a center region of the flexible plate-shaped portion 31 around the axial line S at the center to the inside of the sub housing 20.

The outer peripheral surface of the projecting portion 32 is disposed with an annular clearance from the inner peripheral wall 22 of the sub housing 20.

In addition, the projecting portion 32 serves to transmit a force received by the flexible plate-shaped portion 31 to the piezoelectric element 82 via the holding plate 50, the thermal insulating member 70, and the first electrode 81.

Also, because the projecting portion 32 is provided, the amount of heat transmitted to the diaphragm 30 is restricted by the projecting portion 32 with a narrowed area when the heat is transmitted to the inside of the sub housing 20. It is thus possible to curb the amount of transmitted heat that moves from the diaphragm 30 to the inside.

Here, the shielding plate 40 is formed into a disk shape using the same material as that of the diaphragm 30, that is, a metal material with a precipitation hardening property, such as stainless steel.

As a material for the shielding plate 40, a material with low thermal conductivity, excellent durability, and high rigidity is preferably used, and examples thereof that can be used in addition to the aforementioned stainless steel include a nickel alloy, an iron-based alloy, a titanium alloy, and the like. The thermal conductivity is preferably equal to or less than 15 W/m·K and is more preferably equal to or less than 5 W/m·K, for example.

In a case in which a material with lower thermal conductivity than the diaphragm 30 is used as the material of the shielding plate 40, it is possible to effectively curb the amount of heat transmission transmitted from the pressure medium at a high temperature to the diaphragm 30 through the shielding plate 40, even if the area of the shielding plate 40 is equivalent to the area of the flexible plate-shaped portion 31 of the diaphragm 30.

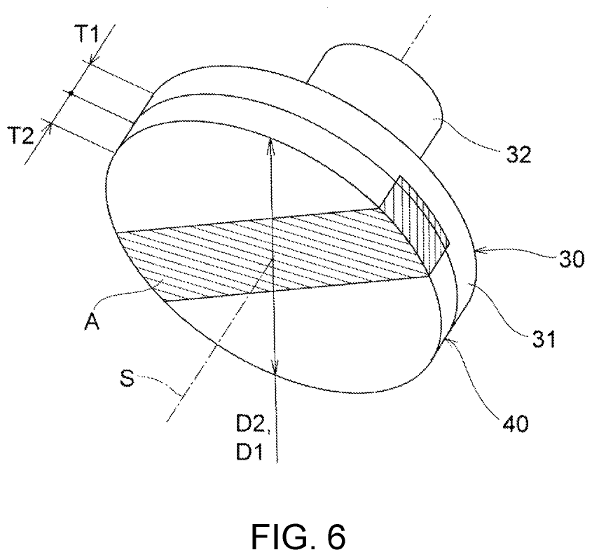

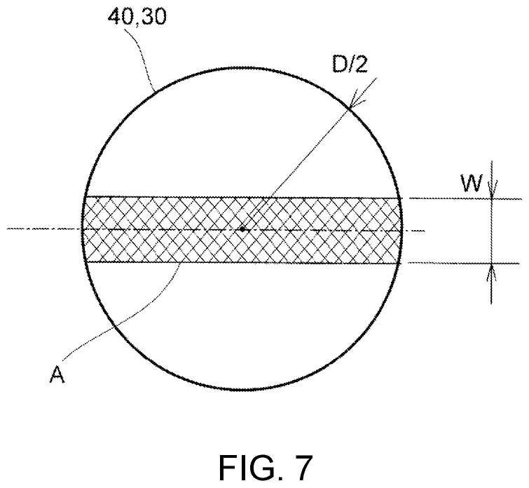

Also, the shielding plate 40 is placed over the flexible plate-shaped portion 31 of the diaphragm 30 from the outer side and is secured to the flexible plate-shaped portion 31 through welding with the linear bonding region A extending in the radial direction, as illustrated in FIG. 6 and FIG. 7. As the welding, for example, laser welding is applied.

Here, the shielding plate 40 is formed to have an outer diameter dimension D2 that is the same as an outer diameter dimension D1 of the flexible plate-shaped portion 31 of the diaphragm 30, and the shielding plate 40 is formed to have a plate thickness T2 that is the same as a plate thickness T1 of the flexible plate-shaped portion 31.

In other words, the shielding plate 40 is exposed to a pressure medium at a high temperature (combustion gas at a high temperature) and covers the diaphragm 30 from the outer side to shield the diaphragm 30 from the pressure medium at a high temperature.

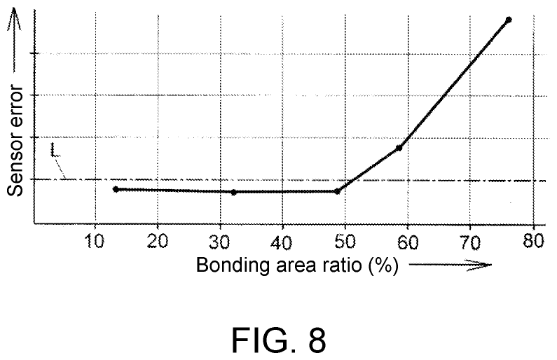

Also, the area of the bonding region A with which the shielding plate 40 is bonded to the flexible plate-shaped portion 31 of the diaphragm 30 is selected on the basis of the properties illustrated in FIG. 8.

In other words, if the bonding area ratio exceeds a percentage in the fifties, an allowable line L of a sensor error is exceeded, and the sensor error deteriorates, according to the relationship between the bonding area ratio (%) that is a proportion of the area of the bonding region A with respect to the area of the shielding plate 40 and the sensor error of the pressure measurement member 80.

As can be understood from the properties illustrated in FIG. 8, it is possible to obtain satisfactory sensor precision by setting the area of the bonding region A to be equal to or less than 50 percent.

Also, it is possible to enhance mechanical bonding strength between the shielding plate 40 and the diaphragm 30 and to curb or prevent degradation of the bonding region with time, by causing the area of the bonding region A to approach 50 percent as much as possible.

In other words, it is possible to curb an adverse influence of the shielding plate 40 limiting the degree of freedom of the diaphragm 30, to obtain a satisfactory influence of the shielding plate 40 curbing or preventing a thermal influence on the diaphragm 30, and thereby to obtain a satisfactory heat shielding effect while securing mechanical strength, by setting the bonding area ratio within the range described above.

Also, in a case in which the shielding plate 40 and the flexible plate-shaped portion 31 are formed into a circular shape with the same outer diameter dimension D (=D2=D1), and when the width dimension of the bonding region A is defined as W as illustrated in FIG. 7, the bonding region A may be formed such that the bonding area of the bonding region A approximates D×W, and the proportion with respect to the area π·(D/2)² of the shielding area 40 is less than 0.5, in other words, the relational expression represented by W<(π·D)/8 is satisfied.

In this case as well, it is possible to curb the adverse influence of the shielding plate 40 limiting the degree of freedom of the diaphragm 30, to obtain the satisfactory influence of the shielding plate 40 curbing or preventing a thermal influence on the diaphragm 30, and to obtain the satisfactory heat shielding effect while securing mechanical strength as described above.

The holding plate 50 is formed into a disk shape with an outer diameter larger than the outer diameter of the projecting portion 32 using a precipitation hardening-type or ferrite-based metal material such as stainless steel, as illustrated in FIG. 4 and FIG. 5.

In addition, the holding plate 50 is sandwiched between the projecting portion 32 of the diaphragm 30 and the thermal insulating member 70, holds the positioning member 60 with separation from the flexible plate-shaped portion 31, and serves to define a space between the flexible plate-shaped portion 31 of the diaphragm 30 and the positioning member 60.

In this manner, it is possible to efficiently curb heat transmission directed from the diaphragm 30 to the inside of the sub housing 20 due to the presence of the aforementioned space.

Note that, the holding plate 50 may be formed of an insulating material and other materials as long as the material has high mechanical rigidity.

The positioning member 60 is formed into a substantially tubular shape extending in the axial line S direction using an insulating material with an electrical insulation property and a thermal insulation property and includes a through-hole 61, a fitting recessed portion 62, an outer peripheral surface 63, and two notch grooves 64 through which the lead wires 101 and 102 are caused to pass, as illustrated in FIG. 4 and FIG. 5.

The through-hole 61 is formed as a circular hole extending around the axial line S at the center and in the axial line S direction.

The fitting recessed portion 62 is formed as a circular recessed portion around the axial line S at the center to receive the holding plate 50.

The outer peripheral surface 63 is formed as a cylindrical surface around the axial line S at the center to be fitted into the inner peripheral wall 22 of the sub housing 20.

The two notch grooves 64 have the same depth dimension in the axial line S direction and are provided at point-symmetrical positions separated from each other by 180 degrees around the axial line S.

Here, as an insulating material for forming the positioning member 60, a material with a high thermal capacity and low thermal conductivity is preferably used. The thermal conductivity is preferably equal to or less than 15 W/m·K and is more preferably equal to or less than 5 W/m·K, for example. Specific examples of the material include ceramics such as quartz glass, steatite, zirconia, cordierite, forsterite, mulite, and yttria and conductive materials on which insulation processing has been performed.

In addition, the positioning member 60 is supported by the holding plate 50 abutting the projecting portion 32, is fitted to the inner peripheral wall 22 of the sub housing 20, and positions and holds, in a laminated state, the thermal insulating member 70 and the pressure measurement member 80 including the first electrode 81, the piezoelectric element 82, and the second electrode 83, and the insulating member 92 in the through-hole 61.

In other words, the positioning member 60 is disposed inside the sub housing 20 that is a part of the housing and serves to fit the thermal insulating member 70, the pressure measurement member 80, and the insulating member 92 into the through-hole 61 to position the thermal insulating member 70, the pressure measurement member 80, and the insulating member 92 on the axial line S of the housing.

It is thus possible to easily position and assemble the thermal insulating member 70 and the first electrode 81, the piezoelectric element 82, and the second electrode 83 configuring the pressure measurement member 80 on the axial line S with reference to the positioning member 60 while securing insulation properties of both electrodes.

Also, the thermal conductivity of the positioning member 60 is preferably equivalent to the thermal conductivity of the thermal insulating member 70 and lower than the thermal conductivity of the insulating member 92. In this manner, it is possible to cause the positioning member 60 to function as a thermal insulating member as well.

Further, since the positioning member 60 is supported by the holding plate 50, is disposed with separation from the flexible plate-shaped portion 31 of the diaphragm 30, and is formed to surround the thermal insulating member 70, it is possible to more efficiently curb heat transmission directed from diaphragm 30 and the wall portion of the housing to the piezoelectric element 72.

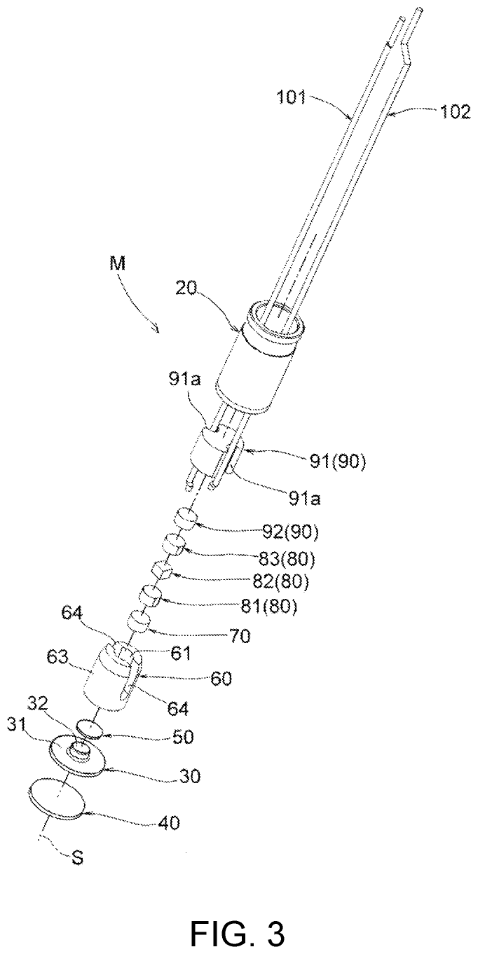

The thermal insulating member 70 is formed into a columnar shape with a predetermined height with an outer diameter equivalent to the outer diameters of the projecting portion 32 and the first electrode 81 using an insulating material with an electrical insulation property and a thermal insulation property, as illustrated in FIG. 3 to FIG. 5.

Here, as an insulation material for forming the thermal insulating member 70, a material with a high thermal capacity and low thermal conductivity is preferably used. The thermal conductivity is preferably equal to or less than 15 W/m·K and is more preferably equal to or less than 5 W/m·K, for example. Specific examples of the material include ceramics such as quartz glass, steatite, zirconia, cordierite, forsterite, mulite, and yttria and conductive materials on which insulation processing has been performed.

In addition, the thermal insulating member 70 is disposed in close contact between the holding plate 50 abutting the projecting portion 32 of the diaphragm 30 and the first electrode 81 inside the sub housing 20. In this manner, the thermal insulating member 70 functions to curb heat transmission from the diaphragm 30 to the first electrode 81.

In other words, a load due to the pressure received by the diaphragm 30 is transmitted to the piezoelectric element 82 via the holding plate 50, the thermal insulating member 70, and the first electrode 81 while the heat transmission from the diaphragm 30 to the first electrode 81 is curbed by the thermal insulating member 70.

Accordingly, it is possible to curb the influence of heat on the piezoelectric element 82 that is adjacent to the first electrode 81, to prevent variations in the reference point (zero point) of sensor outputs, and to obtain prescribed sensor precision.

The pressure measurement member 80 functions to detect a pressure and includes the first electrode 81, the piezoelectric element 82, and the second electrode 83 laminated in order in the axial line S direction from the distal end side inside the sub housing 20, as illustrated in FIG. 3 to FIG. 5.

The first electrode 81 is formed into a columnar shape or a disk shape with an outer diameter with which the first electrode 81 is fitted into the through-hole 61 of the positioning member 60 using a precipitation hardening-type and ferrite-based conductive metal material such as stainless steel.

In addition, the first electrode 81 is disposed such that one surface thereof comes into close contact with the thermal insulating member 70 and the other surface thereof comes into close contact with the piezoelectric element 82 inside the through-hole 61 of the positioning member 60.

The piezoelectric element 82 is formed into a square columnar shape with a dimension with which the piezoelectric element 82 does not come into contact with the through-hole 61 of the positioning member 60.

In addition, the piezoelectric element 82 is disposed such that one surface thereof comes into close contact with the first electrode 81 and the other surface thereof comes into close contact with the second electrode 83 inside the through-hole 61 of the positioning member 60.

In this manner, the piezoelectric element 82 outputs an electric signal on the basis of distortion due to a load received in the axial line S direction.

Note that, as the piezoelectric element 82, a ceramic such as zinc oxide (ZnO), barium titanate (BaTiO₃), or lead zirconate titanate (PZT), crystal, or the like is applied.

The second electrode 83 is formed into a columnar or disk shape with an outer diameter with which the second electrode 83 is fitted into the through-hole 61 of the positioning member 60, using a precipitation hardening-type or ferrite-based conductive metal material such as stainless steel.

In addition, the second electrode 83 is disposed such that one surface thereof comes into close contact with the piezoelectric element 82 and the other surface thereof comes into close contact with the insulating member 92 inside the through-hole 61 of the positioning member 60.

As illustrated in FIG. 3 to FIG. 5, the preload application member 90 is disposed inside the sub housing 20 that is a part of the housing, serves to press the pressure measurement member 80 toward the diaphragm 30, applying a preload thereto, and applying linearity of the sensor to the pressure measurement member 80, and is configured of the securing member 91 and the insulating member 92.

The securing member 91 is formed into a substantially columnar solid shape with no hollow or lightening portion at the center region around the axial line S at the center while occupying an area equivalent to or larger than that of the through-hole 61, using a precipitation hardening-type or ferrite-based metal material such as stainless steel.

Also, the securing member 91 includes two vertical grooves 91a in the outer peripheral region away from the center region.

The two vertical grooves 91a are formed with lightening at point-symmetrical positions 180 degrees from each other around the axial line S such that the lead wires 101 and 102 are caused to pass therethrough.

The insulating member 92 is formed into a columnar or disk shape with an outer diameter with which the insulating member 92 is fitted into the through-hole 61 of the positioning member 60 using an insulating material with a high electrical insulation property.

In other words, the insulating member 92 is formed into a solid shape with no hollow or lightening portion in the entire region that occupies an area equivalent to that of the through-hole 61.

In addition, the insulating member 92 functions to maintain electrical insulation between the second electrode 83 and the securing member 91 and guide the heat transmitted to the piezoelectric element 82 to the securing member 91 for heat dissipation.

Note that, in this embodiment, the thermal insulating member 70, the first electrode 81, the second electrode 83, and the insulating member 92 are formed to have substantially the same outer diameter dimensions and substantially the same thickness dimensions, that is, substantially the same shapes.

As an insulating material for the insulating member 92, a material with a low thermal capacity and high thermal conductivity is preferably used, and specific examples of the material include ceramics such as alumina, sapphire, aluminum nitride, and silicon carbide and conductive materials on which insulation processing has been performed.

Also, as the insulating member 92, an insulating member with higher thermal conductivity than the thermal insulating member 70, for example, thermal conductivity equal to or less than 30 W/m·K is preferable. Also, as the insulating member 92, an insulating member with a lower thermal capacity than the thermal insulating member 70 is preferable. In this manner, it is possible to curb the amount of heat transmitted to the piezoelectric element 82 with the thermal insulating member 70 and to promote dissipation of the heat transmitted to the piezoelectric element 82 through the insulating member 92.

In assembling the preload application member 90 with the aforementioned configuration, the insulating member 92 is fitted into the through-hole 61 to abut the second electrode 83 in a state in which the pressure measurement member 80 is disposed in the positioning member 60 as illustrated in FIG. 4 and FIG. 5. Then, the pressure measurement member 80 is pressed toward the diaphragm 30 in the axial line S direction such that the securing member 91 abuts the insulating member 92, and the securing member 91 is secured to the sub housing 20 through welding or the like in a state in which a preload is applied.

In this manner, it is possible to apply linearity of the sensor to the pressure measurement member 80 by applying the preload with the preload application member 90. Also, the insulating member 92 functions to maintain electrical insulation between the second electrode 83 and the securing member 91 and guide the heat transmitted to the piezoelectric element 82 to the securing member 91 for heat dissipation. Therefore, the insulating member 92 preferably has high thermal conductivity and low thermal capacity as described above.

The lead wire 101 is electrically connected to the first electrode 81 of the pressure measurement member 80, passes through one of the notch grooves 64 of the positioning member 60, one of the vertical grooves 91a of the securing member 91, and the penetrating path 14 of the outer housing 10, and is guided to the connector 110 in a state in which the lead wire 101 is drawn from the outer housing 10 with insulation, as illustrated in FIG. 2 and FIG. 4.

In other words, the first electrode 81 is connected to a terminal 112 of the connector 110 via the lead wire 101 and is electrically connected to the ground side (negative side) of an electric circuit via an outer connector.

The lead wire 102 is electrically connected to the second electrode 83 of the pressure measurement member 80, passes through the other notch groove 64 of the positioning member 60, the other vertical groove 91a of the securing member 91, and the penetrating path 14 of the outer housing 10 and is guided to the connector 110 in a state in which the lead wire 102 is drawn from the outer housing 10 with insulation, as illustrated in FIG. 2 and FIG. 4.

In other words, the second electrode 83 is connected to a terminal 113 of the connector 110 via the lead wire 102 and is electrically connected to the output side (positive side) of the electric circuit via the outer connector.

As illustrated in FIG. 2, the connector 110 includes a joined portion 111 bonded to the connector coupling portion 17 of the outer housing 10, the terminal 112 secured to the joined portion 111 and electrically connected to the lead wire 101, and the terminal 113 secured to the terminal 112 via the insulating member and electrically connected to the lead wire 102.

The terminals 112 and 113 are each adapted to be connected to the connection terminals of the outer connectors.

Next, operations of assembling the pressure sensor with the aforementioned configuration will be described.

For the operations, the outer housing 10, the sub housing 20, the diaphragm 30, the shielding plate 40, the holding plate 50, the positioning member 60, the thermal insulating member 70, the first electrode 81, the piezoelectric element 82, the second electrode 83, the securing member 91, the insulating member 92, the lead wire 101, the lead wire 102, and the connector 110 are prepared.

First, the flexible plate-shaped portion 31 of the diaphragm 30 is secured to the distal end surface 23 of the sub housing 20 through welding or the like.

Then, the shielding plate 40 is placed over the flexible plate-shaped portion 31 of the diaphragm 30 to cover the flexible plate-shaped portion 31 from the outer side, laser welding with a predetermined width W is performed thereon to define the linear bonding region A to pass through the center, and the shielding plate 40 is thus integrally secured with the diaphragm 30.

Next, the holding plate 50 and the positioning member 60 are fitted into the sub housing 20, and then the thermal insulating member 70, the first electrode 81 with the lead wire 101 connected thereto, the piezoelectric element 82, the second electrode 83 with the lead wire 102 connected thereto, and the insulating member 92 are laminated in order and fitted into the positioning member 60.

Note that, the lead wires 101 and 102 may be connected to the first electrode 81 and the second electrode 83, respectively, in the later process.

Thereafter, the securing member 91 is secured to the sub housing 20 through welding or the like in a state in which the securing member 91 is fitted into the sub housing 20 with the insulating member 92 pressed against the securing member 91 and a preload is applied thereto.

In this manner, a sensor module M is formed as illustrated in FIG. 4 and FIG. 5.

Note that the method for assembling the sensor module M is not limited to the aforementioned procedure, and the holding plate 50, the thermal insulating member 70, the first electrode 81, the piezoelectric element 82, the second electrode 83, and the insulating member 92 may be assembled in the positioning member 60 in advance, the positioning member 60 with the aforementioned various components assembled therein may be fitted into the sub housing 20, and the securing member 91 may be secured to the sub housing 20 through welding or the like in which the preload is applied.

Then, the sensor module M is assembled in the outer housing 10. In other words, the lead wires 101 and 102 are caused to pass through the penetrating path 14 of the outer housing 10, the sub housing 20 is fitted to the fitting inner peripheral wall 12 of the outer housing 10, and the further-side end surface 24 is caused to abut the step difference portion 13.

Thereafter, the sub housing 20 is secured to the outer housing 10 through welding.

Next, the joined portion 111 is secured to the connector coupling portion 17 of the outer housing 10.

Then, the lead wire 101 is connected to the terminal 112, and then the terminal 112 is secured to the joined portion 111.

Next, the lead wire 102 is connected to the terminal 113, and then the terminal 113 is secured to the terminal 112 via the insulating member. In this manner, the connector 110 is secured to the outer housing 10.

As described above, the assembly of the pressure sensor is completed.

Note that, the aforementioned assembling procedure is just an example, the present invention is not limited thereto, and another assembling procedure may be employed.

According to the pressure sensor of the aforementioned first embodiment, since the shielding plate 40 is secured to the flexible plate-shaped portion 31 of the diaphragm 30 with the linear bonding region A, the diaphragm 30 is shielded by the shielding plate 40 from the pressure medium (combustion gas) at a high temperature, distortion of the diaphragm 30 due to thermal expansion is curbed or prevented, and a sensor error of the pressure measurement member 80 is reduced. It is thus possible to detect the pressure of the high-temperature pressure medium with high precision.

Also, since the shielding plate 40 is bonded and secured to the diaphragm 30 with the linear bonding region A, mechanical strength of the bonding is enhanced as compared with a case in which only the center region is secured, and it is possible to curb degradation with time and to prevent the shielding plate 40 from dropping.

Further, the heat transmitted to the diaphragm 30 is insulated by the thermal insulating member 70, and heat transmission from the diaphragm 30 to the first electrode 81 and the piezoelectric element 82 is curbed. Therefore, the influences of the heat on the piezoelectric element 82 is curbed, variations in reference point (zero point) of sensor outputs can be prevented, and prescribed sensor precision can be obtained.

Here, the thermal insulating member 70 is formed of an insulating material, the first electrode 81 is connected directly to the electric circuit via the lead wire 101, and the second electrode 83 is connected directly to the electric circuit via the lead wire 102. It is thus possible to prevent a leak current from being generated and to maintain prescribed sensor properties.

Further, the housing includes the outer housing 10 and the sub housing 20 fitted and secured to the inside of the outer housing 10, and the shielding plate 40, the diaphragm 30, the holding plate 50, the positioning member 60, the thermal insulating member 70, the pressure measurement member 80, and the preload application member 90 are disposed in the sub housing 20.

In this manner, it is possible to form the sensor module M by assembling the shielding plate 40, the diaphragm 30, the holding plate 50, the positioning member 60, the thermal insulating member 70, the pressure measurement member 80, and the preload application member 90 with the sub housing 20 in advance.

Therefore, in a case in which the attachment shapes and the like differ depending on targets of applications, it is possible to share the sensor module M by setting only the outer housing 10 for each of the targets of applications.

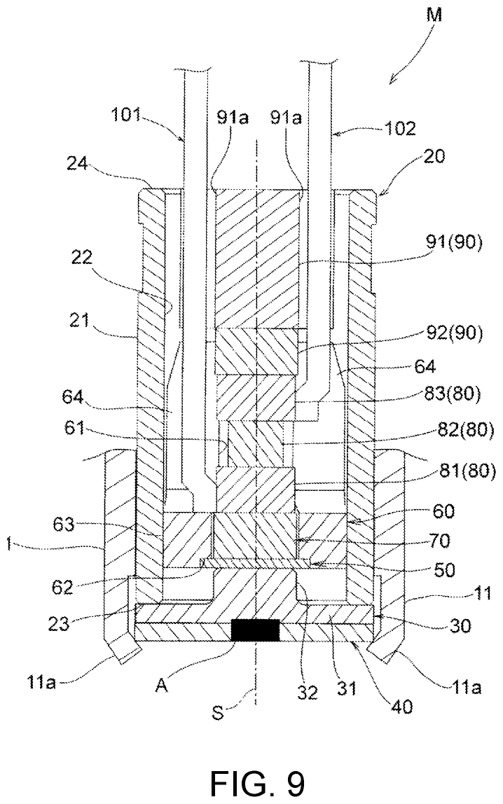

FIG. 9 illustrates a modification example in which the distal end tubular portion 11 of the outer housing 10 is processed in the sensor module M according to the first embodiment.

In the modification example, the sensor module M is assembled in the outer housing 10, and the distal end annular region 11a of the distal end tubular portion 11 of the outer housing 10 is then folded toward the axial line S to cover the outer peripheral edge of the shielding plate 40.

It is possible to prevent the pressure medium at a high temperature from advancing to the side of the diaphragm 30 from the periphery of the shielding plate 40 by the distal end annular region 11a being folded as described above. As a result, it is possible to further curb or prevent the influence of heat on the diaphragm 30.

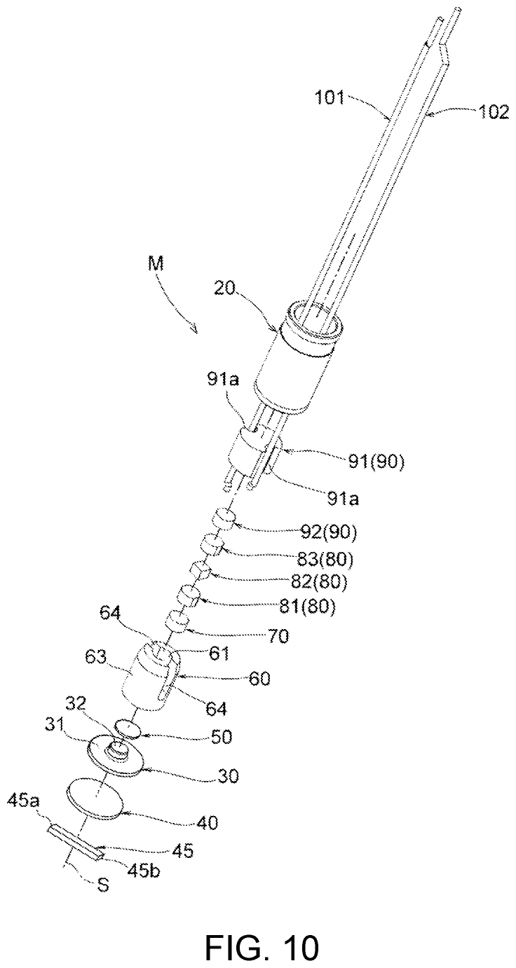

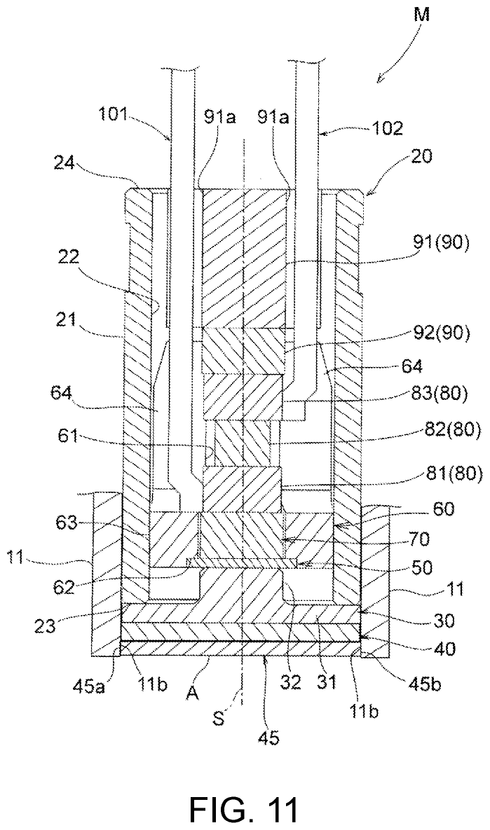

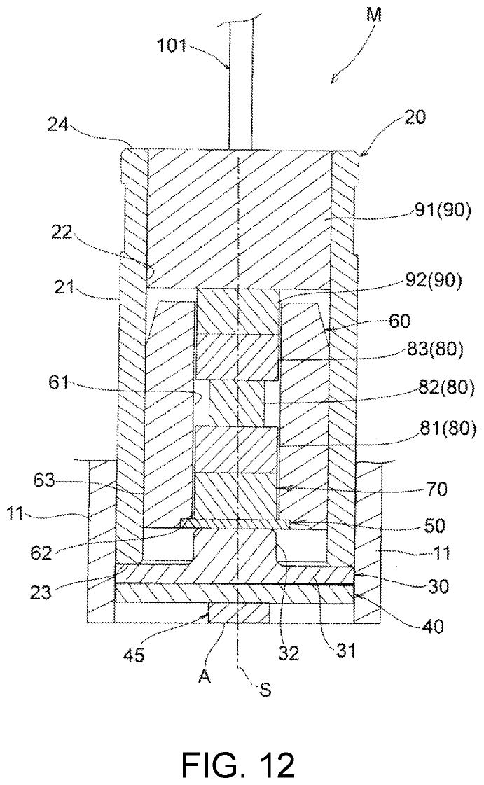

FIG. 10 to FIG. 12 illustrate a second embodiment of the pressure sensor according to the present invention, and a configuration in which a securing member 45 is employed to secure a shielding plate 40 to a diaphragm 30 is employed instead of the configuration of the first embodiment in which the shielding plate 40 is secured through welding. The same reference signs will be applied to the same components as those in the first embodiment, and description thereof will be omitted.

The pressure sensor according to the second embodiment includes: an outer housing 10 and a sub housing 20 that are housings, a diaphragm 30, a shielding plate 40, a securing member 45, a holding plate 50, a positioning member 60, a thermal insulating member 70, a pressure measurement member 80, a preload application member 90, a lead wire 101 that is a first conductive element, a lead wire 102 that is a second conductive element, and a connector 110.

The securing member 45 is formed to have the same area as the aforementioned linear bonding region A from the axial line S direction, using the same material as that of the shielding plate 40, for example, a metal material with a precipitation hardening property such as stainless steel.

In other words, the securing member 45 defines the aforementioned linear bonding region A, and a length dimension and a width dimension W corresponding to the aforementioned outer diameter dimension D can be applied as the outer dimensions thereof. Also, the thickness dimension of the securing member 45 is set to be equivalent to the thickness dimension T2 of the shielding plate 40, for example.

It is possible to curb different thermal properties between the securing member 45 and the shielding plate 40 by using the same material for the securing member 45 and the shielding plate 40, and thereby to secure the shielding plate 40 to the diaphragm 30.

In the assembling of the pressure sensor according to the second embodiment, the sensor module M in which components other than the shielding plate 40 and the securing member 45 have been assembled is prepared first.

Then, after the sensor module M is assembled in the outer housing 10 and is secured thereto through welding or the like, the shielding plate 40 is fitted into the distal end tubular portion 11 to cover the diaphragm 30.

Next, the securing member 45 is disposed adjacent to the outer side of the shielding plate 40, and both end portions 45a and 45b of the securing member 45 are secured to an inner wall surface 11b of the distal end tubular portion 11 through welding in a state in which the shielding plate 40 is pressed against the flexible plate-shaped portion 31.

In this manner, the shielding plate 40 is secured to the flexible plate-shaped portion 31 using the securing member 45 that defines the linear bonding region A.

According to the pressure sensor of the second embodiment, since the shielding plate 40 is secured to the flexible plate-shaped portion 31 of the diaphragm 30 with the securing member 45 that defines the linear bonding region A, the diaphragm 30 is shielded by the shielding plate 40 from the pressure medium (combustion gas) at a high temperature, distortion of the diaphragm 30 due to thermal expansion is curbed or prevented, and a sensor error of the pressure measurement member 80 is reduced. In this manner, it is possible to detect the pressure of the high-temperature pressure medium with high precision.

Also, since the shielding plate 40 is pressed by the securing member 45 and is bonded and secured to the diaphragm 30, the degree to which the degree of freedom of the diaphragm 30 is limited is reduced, and it is possible to curb or prevent thermal influences and to prevent the shielding plate 40 from dropping while curbing degradation with time.

Although the diaphragm 30 in which the flexible plate-shaped portion 31 and the projecting portion 32 are integrally provided has been described as a diaphragm, the present invention is not limited thereto, and a configuration in which the flexible plate-shaped portion 31 and the projecting portion 32 are formed separately, the flexible plate-shaped portion 31 functions as a diaphragm, and the projecting portion 32 functions as a power transmission member may be employed.

Although the configuration in which the outer housing 10 and the sub housing 20 are included as housings has been described in the aforementioned embodiments, the present invention is not limited thereto, and one housing may be employed.

As described above, since the pressure sensor according to the present invention can reliably shield the diaphragm from a pressure medium at a high temperature, can curb the influence of heat and degradation with time, and can detect the pressure of the high-temperature pressure medium with high precision, it is a matter of course that the pressure sensor can be applied as a pressure sensor for detecting the pressure of a high-temperature pressure medium such as combustion gas in a combustion chamber of an engine, in particular, and the pressure sensor is also useful as a pressure sensor for detecting the pressure of a pressure medium at a high temperature other than the combustion gas or of other pressure media.

It will be apparent to those skilled in the art that various modifications and variations can be made to the disclosed embodiments without departing from the scope or spirit of the disclosure. In view of the foregoing, the disclosure is intended to cover modifications and variations provided that they fall within the scope of the following claims and their equivalents.

What is claimed is:

1. A pressure sensor comprising:
a housing, formed into a tubular shape;
a pressure measurement member, accommodated in the housing and including a piezoelectric element;
a diaphragm, including: a flexible plate-shaped portion secured to a distal end of the housing, and a projecting portion adapted to transmit a load to the pressure measurement member; and
a shielding plate, disposed adjacent to the flexible plate-shaped portion to shield the diaphragm from a pressure medium,
wherein the shielding plate is secured to the flexible plate-shaped portion by a bonding region in a linear shape.

2. The pressure sensor according to claim 1, wherein
the shielding plate is linearly welded to the flexible plate-shaped portion.

3. The pressure sensor according to claim 2, wherein
a distal end annular region of the housing is bent to cover an outer peripheral edge of the shielding plate.

4. The pressure sensor according to claim 1, further comprising:
a securing member in a linear shape that is disposed adjacent to an outer side of the shielding plate and defines the bonding region,
wherein both end portions of the securing member are welded to the housing in a state in which the shielding plate is pressed against the flexible plate-shaped portion.

5. The pressure sensor according to claim 1, wherein
an area of the bonding region is equal to or less than 50% of an area of the shielding plate.

6. The pressure sensor according to claim 5, wherein
when the flexible plate-shaped portion and the shielding plate have a circular shape with an outer diameter dimension D,
a width dimension W of the bonding region satisfies a relational expression represented as W<(π·D)/8.

7. The pressure sensor according to claim 1, wherein
the shielding plate is formed of a material that has same thermal conductivity as or lower thermal conductivity than the diaphragm.

8. The pressure sensor according to claim 4, wherein
the securing member is formed of the same material as the shielding plate.

9. The pressure sensor according to claim 1, wherein
the pressure measurement member includes a first electrode and a second electrode laminated to pinch the piezoelectric element,
a first conductive element drawn from the housing with insulation is connected to the first electrode, and
a second conductive element drawn from the housing with insulation is connected to the second electrode.
